(19) United States
(12) Patent Application Publication
(10) Pub. No.: US 2018/0203517 A1
(43) Pub. Date: Jul. 19, 2018

(54) METHOD AND OPERATOR CONTROL SYSTEM FOR OPERATING AT LEAST ONE FUNCTION IN A VEHICLE

(71) Applicant: AUDI AG, Ingolstadt (DE)

(72) Inventor: Ralph HOLLMIG, Ingolstadt (DE)

(73) Assignee: AUDI AG, Ingolstadt (DE)

(21) Appl. No.: 15/744,649

(22) PCT Filed: Apr. 29, 2016
(86) PCT No.: PCT/EP2016/000702

§ 371 Date: Jan. 12, 2018

(30) Foreign Application Priority Data
Jul. 16, 2015 (DE) 10 2015 213 424.5

(51) Int. Cl. G06F 3/01; B60K 37/06; G03H 1/22; G03H 1/00

(52) U.S. Cl. CPC G06F 3/017; B60K 37/06; G03H 1/2249; G03H 1/0005; B60K 2350/1052; G03H 2001/0061; B60K 2350/2026; B60K 2350/2047; B60K 2350/2052; B60K 2350/2065; B60K 2350/922; B60K 2350/2013

(57) ABSTRACT

A display generator, after activation of a display area assigned to at least one function in the interior of a vehicle, holographically displays virtual operator control elements assigned to the at least one function in the display area assigned to the at least one function in the interior of the vehicle. A detection and sensing device detects and senses gestures by a vehicle occupant which are to be interpreted as operator control inputs upon the virtual operator control elements being actuated in a manner desired by the vehicle occupant. A computing unit interprets the gestures as operator control inputs and initiates an implementation, corresponding to the operator control inputs, of the at least one function.

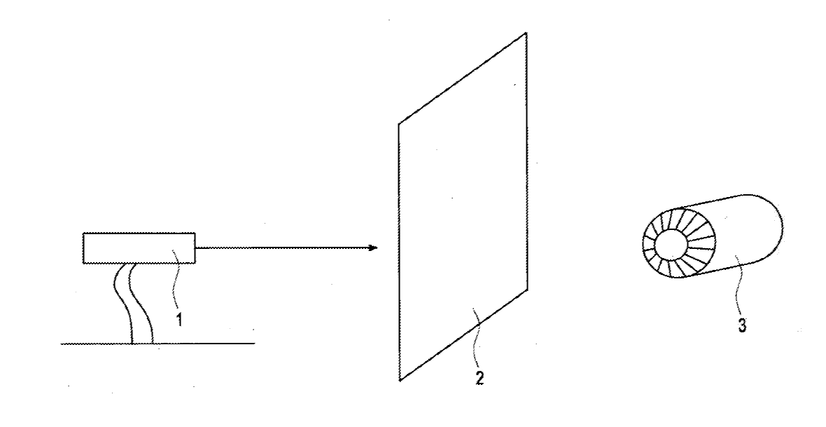

### CROSS REFERENCE TO RELATED APPLICATIONS

This application is the U.S. national stage of International Application No. PCT/EP2016/000702, filed Apr. 29, 2016, and claims the benefit thereof. The International Application claims the benefit of German Application No. 10 2015 213 424.5 filed on Jul. 16, 2015, both applications are incorporated by reference herein in their entirety.

### BACKGROUND

Described below is an operator control system for operating at least one function in an interior of a vehicle. Also described are a corresponding method and a vehicle having the operator control system.

At the present time, functions in a vehicle are generally operated and displayed in a conventional manner, i.e. using rotary buttons, pushbuttons, switches, etc. In this regard, e.g. switches or buttons exist for controlling safety components, such as e.g. an electronic safety assistant, convenience devices, such as e.g. a seat adjustment system, a seat heating system, electrical window winding systems, electrically adjustable exterior mirrors, or components of an infotainment system, such as e.g. a navigation system or an automobile radio.

The display apparatuses generally provided in the vehicles are often configured as LCDs for displaying operational data.

Such operator control and/or display devices are provided e.g. below an upper edge of a dashboard or in the region of a center console in the field of view of a corresponding driver.

It is furthermore known to provide in the vehicle display devices in which a virtual image visible to the driver or a further vehicle occupant is generated in the region of a windshield of the vehicle. Such devices are referred to as head-up displays (HUDs).

The interior of a respective vehicle is equipped with many buttons and switches on account of an extensive range of functions. In this case, the buttons and switches are visually visible even when not in use. This leads to a very complex appearance for a respective driver. As a result, it is conceivable that the driver will be distracted from road traffic too much on account of the complexity and the multiplicity of the operator control and/or display elements. There is an incalculable safety risk.

EP 1 798 588 A1 discloses an operator control system for operating functions in a vehicle with a display device for graphically displaying virtual operator control elements assigned to the functions on an assigned display surface in the vehicle, and a sensing device for sensing operator control inputs upon an actuation of the virtual operator control elements.

DE 10 2008 059 810 A1 discloses an operator control system for operating functions in a motor vehicle with an optical projection system for graphically reproducing virtual display elements and/or virtual operator control elements on an assigned display surface in the motor vehicle, and a sensing device for sensing operator control inputs upon an actuation of the virtual operator control elements.

DE 10 2006 000 777 A1 discloses a method and an apparatus for vehicle access control using an imaged keyboard.

### SUMMARY

The operator control system described below operates at least one function in an interior of a vehicle which enables simple operator control that causes little distraction from road traffic for a respective driver, and which furthermore has a small space requirement.

The operator control system includes a display generator which, after activation of a display area assigned to the at least one function in the interior of the vehicle, is configured for holographically displaying at least one virtual operator control element assigned to the at least one function in the display area assigned to the at least one function in the interior of the vehicle, a detection and sensing device configured for detecting and sensing at least one gesture by a vehicle occupant which is to be interpreted as an operator control input upon the at least one virtual operator control element being actuated in a manner desired by the vehicle occupant, and a computing unit designed to interpret the gesture as an operator control input and to initiate an implementation, corresponding to the operator control input, of the at least one function.

In accordance with one configuration of the operator control system, the display generator includes a light source and an optical projection system. The display generator has access to a storage medium, in particular a holographic photographic plate, on which a stored image or a hologram of one or a plurality of operator control elements is stored. The photographic plate is or has been installed in the vehicle and is backlit upon activation of the display area by a light source, such as a laser. As a result, one virtual operator control element or a plurality of virtual operator control elements become(s) visible, which corresponds or correspond to the stored image of the one or the plurality of operator control elements. This hologram of one or a plurality of operator control elements, which shows the respective operator control elements in the form of a button, a rotary/pushbutton switch or the like, is visible for a duration of use.

Besides the storage medium, in particular the holographic photographic plate, the display generator may include a processor to image the hologram. Alternatively, the display generator may be connected to a separate processor and/or memory to image and/or to reconstruct the hologram. Furthermore, the display generator and the detection and sensing device can also share a common processing unit. Furthermore, it is conceivable for a library having predetermined holograms for selection of virtual operator control elements by a driver or a further vehicle occupant to be stored in a storage section of the storage medium in the display generator.

In the context of the system and method described herein, the term hologram denotes a stored image which corresponds to a photographic recording that is produced by holographic techniques and, after preparation and illumination with light of the same type, reproduces a genuine three-dimensional image of an original object, here of at least one operator control element. The optical projection system provided as part of the display generator serves for reproducing the hologram. The optical projection system may include a holographic photographic plate as storage medium, and optionally an optical projection lens for projecting the hologram stored on the storage medium of the display generator. A reflective mirror, a lens, a combiner or any combination thereof can be used to alter the projected hologram depending on a desired display. Various components or else a defined air zone in the interior of the vehicle can serve as the display area, such that displays occupying a large accommodation space can be dispensed with. The air zone can be e.g. a free area in front of a windshield of the vehicle, in front of a center console of the vehicle or the like. This results in good design freedoms and low production costs on account of the smaller space requirement needed. Moreover, specific components in the interior of the vehicle which serve as the display area can be allocated a dual function in the vehicle since, besides their own function, such as e.g. the function of a storage compartment, they have a further function, namely that of forming the display area or at least part of the display area. Furthermore, disturbing reflections emanating from e.g. display covers and lines of intersection can be avoided.

Switches, buttons, steering column levers, longitudinal column adjustment and integration of sensors into a control panel can be completely obviated.

The interior of the vehicle is divided into function or display areas in which in each case different functions can be displayed by the display generator of correspondingly different virtual operator control elements, as necessary, by a respective holographic display or a respective hologram. The display generator displays the virtual operator control elements assigned to the at least one function in the display area assigned to the at least one function in the interior of the vehicle only after activation of the display area assigned to the at least one function in the interior of the vehicle.

In a possible configuration of the operator control system, this means that the display area is automatically activated only when an element performing the gestures, in particular a hand of a vehicle occupant, enters a defined operative area assigned to the display area and the at least one or the plurality of virtual operator control elements assigned to the at least one function is or are made visible as a result. That means that the display area is activated only when e.g. a hand enters the operative area assigned to the corresponding display area, such that it is only then that the stored hologram assigned to the display area is displayed by the display generator and therefore it is only then, too, that the at least one or the plurality of operator control elements reproduced by the hologram can be operated by at least one corresponding gesture that is to be interpreted as an operator control input.

In a further configuration, the operator control system is designed automatically to deactivate the display area after initiation of the corresponding implementation of the function, whereby the virtual operator control elements, in particular the operator control elements shown by the holographic display, are made invisible. To that end, the light source used for the backlighting of the holographic photographic plate is deactivated or switched off automatically, for example.

It is furthermore conceivable for the operator control system to be designed automatically to deactivate the display area, once it has been activated, after a defined time duration if no gesture to be interpreted as an operator control input is sensed. That means that if a driver or a further vehicle occupant inadvertently enters the operative area of a display area assigned to the operative area, and the display area is thereby activated, although the driver does not wish to operate the virtual operator control elements then displayed, the display automatically disappears again after a certain time since the respective display area is automatically deactivated again and the operator control elements are made invisible as a result.

In a further configuration of the operator control system, the detection and sensing device and/or the display generator are/is arranged in the region of a front roof console of the vehicle, wherein the at least one virtual operator control element assigned to the at least one function is displayed in an area of a dashboard of the vehicle.

A vehicle may be produced with the above-described operator control system.

A method for operating at least one function in an interior of a vehicle includes at least the following:

holographically displaying at least one virtual operator control element assigned to the at least one function in a display area assigned to the at least one function in the interior of the vehicle,

detecting and sensing at least one gesture by a vehicle occupant which is to be interpreted as an operator control input for the at least one operator control element,

interpreting the at least one gesture as an operator control input for the at least one operator control element, and

initiating an implementation, corresponding to the operator control input, of the at least one function.

In a possible configuration, the method furthermore includes providing a hologram displaying the at least one operator control element, the hologram being stored on a holographic photographic plate. The hologram or the stored image is generated by a known holographic technique. In this case, a real operator control element to be displayed virtually is illuminated with coherent light from a light source, in particular a laser. The light is reflected and scattered. This gives rise to a wave field perceptible to the eyes, the wave field also being called an object wave. The object wave is superimposed with the incident, non-scattered light, the so-called reference wave, from the same laser, that is to say that respective wavefronts of the object wave and of the reference wave interfere with one another. The resulting interference patterns impinge on the holographic photographic plate and are recorded there as a hologram, which can be imaged again and thus displayed by corresponding backlighting, generally with a wave identical to the reference wave. As a result, the initially recorded operator control element stored in the hologram is spatially imaged, i.e. spatially displayed virtually.

In this case, holographically displaying includes correspondingly illuminating the hologram displaying the at least one operator control element or the plurality of operator control elements.

In a further configuration, the interpreting includes comparing the at least one gesture with gestures stored in a retrievable storage unit.

In accordance with a further embodiment of the operator control system, the projection system formed by the display generator projects, besides the virtual operator control elements, further image elements, such as e.g. actual values of predetermined vehicle systems, e.g. of a convenience system. As a result, the operator control system includes both a display function for displaying system values and the actuatable operator control elements and a function for realizing the operator control elements per se which are selected and activated by corresponding gestures.

In accordance with a further embodiment of the operator control system, a central control unit is provided, which is connected to a sensor system for sensing an activation of the display area, to the detection and sensing device and to the projection system.

The sensor for sensing an activation of the display area can be e.g. an optical unit such as a camera, for example, which is designed to detect as soon as e.g. a hand of a vehicle occupant passes into the operative area assigned to the display area, whereby the display area is activated. As soon as the sensor for sensing an activation of the display area detects that e.g. a hand of the driver passes into the operative area of the display area, a corresponding signal is transmitted to the central control unit, which thereupon activates the projection system, in particular the light source connected to the projection system, whereby the at least one operator control element assigned to the function is holographically displayed. Furthermore, the central control unit brings about an activation of the detection and sensing device, such that a gesture possibly made for operating the at least one holographically displayed operator control element can be detected and correspondingly sensed. The sensor for sensing an activation of the display area can be integrated in or concomitantly provided by the detection and sensing device for detecting and sensing gestures to be interpreted as operator control inputs. As a result of the connection of the detection and sensing device and also of the projection system and of the light source connected thereto to the central control unit, the holographic display of respective operator control elements of generally a plurality of functions is effected automatically as necessary or automatically as soon as an executive element such as e.g. a hand passes into an operative area assigned to the respective display area and in so doing is sensed by the sensor for sensing an activation of the corresponding display area.

Furthermore, it is conceivable for the central control unit to effect a changing holographic display of the virtual operator control elements depending on the sensed gestures that are to be interpreted as operator control inputs.

As a result, alterable or variable operator control elements can also be displayed in a common display area, wherein optionally a plurality of menu levels are displayable and implementable. The central control unit drives the display generator in such a way that the menu level assigned to the actuated virtual operator control elements or the assigned new graphical symbols is or are displayed in the display area.

It is also conceivable for the central control unit to drive the display generator or the projection system provided by the display generator for displaying virtual operator control elements depending on specific, instantaneous driving parameters. By way of example, in the event of a vehicle accident having been identified, emergency call numbers, a hazard warning symbol and other useful actuatable operator control elements are automatically imaged graphically by the projection system in the assigned display area. As a result, displayed operator control elements are not cluttered. Rather, only currently expedient operator control elements allocated with a high selection probability are displayed to a vehicle occupant in the assigned display area. By way of example, an area in the vicinity of a center console or a roof liner, a sun visor, a dashboard, a side trim, a vehicle window and/or other vehicle components can serve as the display area. The detection and sensing device can identify gestures interpretable as operator control inputs and, via the central control unit described above, for example, initiate the implementation of the corresponding operator control inputs or the function assigned to the operator control inputs. In this case, the detection and sensing device can be arranged e.g. in the region of the front roof console, the longitudinal column trim, the door trim, the outer roof frame, the side trim or the like.

In a possible configuration, the detection and sensing device includes a camera that optically senses an actuation of the virtual operator control elements.

The plurality of virtual operator control elements are generally assigned to different vehicle functions. It is conceivable for exactly one virtual operator control element to be assigned to each function. However, it is also conceivable for a plurality of operator control elements to be provided for one function. These vehicle functions can correspond e.g. to safety functions, convenience functions and/or infotainment functions.

Further advantages and configurations of the operator control system are evident from the description and the accompanying drawing.

It goes without saying that the features mentioned above and those yet to be explained below can be used not only in the combination respectively indicated, but also in other combinations or by themselves, without departing from the scope of the present invention.

### BRIEF DESCRIPTION OF THE DRAWINGS

The operator control system is schematically illustrated on the basis of embodiments in the drawing and is described schematically or thoroughly with reference to the drawing.

The single drawing is a schematic illustration of how an operator control element is virtually displayed in accordance with one embodiment of the method.

### DETAILED DESCRIPTION OF THE PREFERRED EMBODIMENT

The drawing includes an illumination source 1, a holographic photographic plate 2 and a virtually displayed operator control element 3. The holographic photographic plate 2 is arranged in a vehicle, not illustrated here, at a suitable location, such as e.g. in the region of a center console of the vehicle. The illumination source 1, which is generally a laser, is arranged behind the photographic plate 2 from the viewpoint of a vehicle occupant, such as e.g. a driver. The photographic plate 2 and the spatial area around the photographic plate define a display area. If the driver would then like to implement a function to be activated by the operator control element 3, the driver brings his/her hand or just a finger of the hand in proximity to the photographic plate 2 and thus into an operative area which surrounds the display area and which is assigned to the display area. This is detected by a sensor system, not shown here, whereby the display area is activated and thus so is the illumination source 1, with the result that the latter illuminates the photographic plate 2. A hologram is stored on the photographic plate 2, the operator control element being captured or recorded in the hologram. As a result of the illumination of the photographic plate 2 or of the hologram stored thereon, the operator control element 3 is spatially displayed virtually. In this case, however, the light emitted by the illumination source 1 must correspond exactly to the light with which the hologram stored on the photographic plate 2 was recorded. The driver can then operate the operator control element 3 by suitable gestures or by at least one gesture. The gestures made by the driver or the at least one gesture made by the driver are or is identified and interpreted by a detection and sensing device, not illustrated here, and forwarded to a control unit, likewise not illustrated here, which then initiates a corresponding implementation of the function associated with the operator control element 3.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-14. (canceled)

15. An operator control system for operating at least one function in an interior of a vehicle, comprising:
a display generator configured to holographically display at least one virtual operator control element assigned to at least one function, after activation of a display area assigned to the at least one function in the interior of the vehicle;
a detection and sensing device configured to detect and sense at least one gesture by a vehicle occupant as an operator control input upon the at least one virtual operator control element; and
a computing unit configured to interpret the at least one gesture as the operator control input and to initiate an implementation, corresponding to the operator control input, of the at least one function.

16. The operator control system as claimed in claim 15,
further comprising a storage medium, and
wherein the display generator is configured to realize the holographic display of the at least one virtual operator control element assigned to the at least one function in the assigned display area by displaying a hologram correspondingly illuminated and retrievable from the storage medium.

17. The operator control system as claimed in claim 15, wherein the display generator comprises a light source and an optical projection system.

18. The operator control system as claimed in claim 17, wherein the light source is a laser.

19. The operator control system as claimed in claim 17, wherein the optical projection system comprises at least one holographic photographic plate on which a hologram that images the at least one virtual operator control element is recorded.

20. The operator control system as claimed in claim 15, further comprising a controller configured to activate the display area automatically, only when a hand of the vehicle occupant, performing the at least one gesture, enters a defined operative area assigned to the display area, and thereby cause the display generator to holographically display the at least one virtual operator control element assigned to the at least one function.

21. The operator control system as claimed in claim 15, further comprising a controller configured to deactivate the display area automatically, after initiation of the implementation of the at least one function corresponding to the operator control input, so that the at least one virtual operator control element is no longer displayed by the display generator.

22. The operator control system as claimed in claim 15, further comprising a controller configured to deactivate the display area automatically, a defined time duration after activation of the display area without sensing any gesture interpreted as an operator control input.

23. The operator control system as claimed in claim 15, wherein the vehicle has a front roof console and a dashboard,
wherein at least one of the detection and sensing device and the display generator is disposed proximate to the front roof console of the vehicle, and
wherein the display generator displays the at least one virtual operator control element assigned to the at least one function proximate to the dashboard of the vehicle.

24. A method for operating at least one function in an interior of a vehicle, comprising:
holographically displaying at least one virtual operator control element assigned to the at least one function in a display area, assigned to the at least one function, in the interior of the vehicle after activation of the display area;
detecting and sensing at least one gesture by a vehicle occupant as an operator control input of the operator control element;
interpreting the at least one gesture as the operator control input of the operator control element; and
initiating an implementation, corresponding to the at least one operator control input, of the at least one function.

25. The method as claimed in claim 24, further comprising providing a recording containing at least one hologram of the at least one operator control element.

26. The method as claimed in claim 25, wherein said holographically displaying comprises correspondingly illuminating the at least one hologram of the at least one operator control element.

27. The method as claimed in claim 24, wherein said interpreting comprises comparing the at least one gesture with gestures stored in and retrieved from a storage unit.

28. A vehicle, comprising:
a chassis; and
an operator control system configured to operate at least one function in an interior of the vehicle, including
a display generator configured to holographically display at least one virtual operator control element assigned to at least one function, after activation of a display area assigned to the at least one function in the interior of the vehicle;
a detection and sensing device configured to detect and sense at least one gesture by a vehicle occupant as an operator control input upon the at least one virtual operator control element; and
a computing unit configured to interpret the at least one gesture as the operator control input and to initiate an implementation of the at least one function corresponding to the operator control input.

29. The vehicle as claimed in claim 28,
wherein the operator control system further comprises a storage medium, and
wherein the display generator is configured to realize the holographic display of the at least one virtual operator control element assigned to the at least one function in the assigned display area by displaying a hologram correspondingly illuminated and retrievable from the storage medium.

30. The vehicle as claimed in claim 28, wherein the display generator comprises a laser and an optical projection system.

31. The vehicle as claimed in claim 30, wherein the optical projection system comprises at least one holographic photographic plate on which a hologram that images the at least one virtual operator control element is recorded.

32. The vehicle as claimed in claim 28, wherein the operator control system further comprises a controller configured to activate the display area automatically, only when a hand of the vehicle occupant, performing the at least one gesture, enters a defined operative area assigned to the display area, and thereby cause the display generator to holographically display the at least one virtual operator control element assigned to the at least one function.

33. The vehicle as claimed in claim 29, wherein the operator control system further comprises a controller configured to deactivate the display area automatically at least one of a defined time duration after activation of the display area without sensing any gesture interpreted as an operator control input, and after initiation of the implementation of the at least one function corresponding to the operator control input, so that the at least one virtual operator control element is no longer displayed by the display generator.

34. The vehicle as claimed in claim 15,
further comprising a front roof console and a dashboard, and
wherein at least one of the detection and sensing device and the display generator is disposed proximate to the front roof console of the vehicle, and
wherein the display generator displays the at least one virtual operator control element assigned to the at least one function proximate to the dashboard of the vehicle.
